(19) United States
(12) Patent Application Publication
(10) Pub. No.: US 2013/0291730 A1
(43) Pub. Date: Nov. 7, 2013

(54) Gas Separation Device

(71) Applicant: Membranotec GmbH & Co. KG, Bremen (DE)

(72) Inventors: Andreas Varesi, Munchen (DE); Klaus Kubatzki, Riemerling (DE); Jorg Thoming, Bremen (DE); Michael Baune, Bremen (DE); George Okoth, Bremen (DE)

(21) Appl. No.: 13/861,088

(22) Filed: Apr. 11, 2013

Related U.S. Application Data
(63) Continuation of application No. PCT/EP2011/067656, filed on Oct. 10, 2011.

(30) Foreign Application Priority Data
Oct. 11, 2010 (DE) 102010042261.4

(51) Int. Cl. B01D 46/00

(52) U.S. Cl. CPC B01D 46/0039
USPC 96/60; 55/529; 55/482; 29/428

(57) ABSTRACT

A gas separation device comprises a gas separation layer, a first gas volume and a second gas volume, the gas separation layer being arranged between the first gas volume and the second gas volume, the gas separation layer having at least one aperture connecting the first gas volume to the second gas volume. The aperture is configured to taper from the first gas volume to the second gas volume and being dimensioned to enrich a component of the second gas volume in the first gas volume, wherein the aperture is configured as an elongated opening in the gas separation layer, the aperture having a minimum opening width of essentially one time to twenty times the mean free path length of the component of the second gas volume, which is to be enriched.

### CROSS-REFERENCE TO RELATED APPLICATIONS

This application is a continuation of PCT International Application No.: PCT/EP2011/067656 filed Oct. 10, 2011, which claims priority under 35 U.S.C. §119 to German Application 10 2010 041 261.4 filed Oct. 11, 2010.

### FIELD OF THE INVENTION

The present invention relates to a gas separation device comprising a gas separation layer, a first gas volume and a second gas volume, the gas separation layer being arranged between the first gas volume and the second gas volume, wherein the gas separation layer comprises at least one aperture connecting the first gas volume to the second gas volume, wherein the aperture is configured to taper from the first gas volume to the second gas volume and is dimensioned to enrich a component of the second gas volume in the first gas volume.

### BACKGROUND

DE 10 2005 055 675 B3 discloses a detecting device for detecting the presence of a gas. The detecting device comprises a capillary unit having one or a plurality of capillaries which connect a first side of the capillary unit to a second side of the capillary unit. Sections of the capillaries are configured to taper from the first side to the second side, the minimal cross-section of the capillaries being smaller than the mean free path length of the predetermined gas under predetermined conditions. By means of this configuration, a gas component of a gas mixture applied at the second side may be enriched towards the first side. However, apart from a complex manufacture of the capillaries, the flow rate of the gas component through the capillaries is limited due to the narrow tube-shaped design of the capillaries.

### SUMMARY

The present invention provides an improved gas separation device which particularly comprises an increased flow rate and is easier to manufacture.

According to a first aspect, a gas separation device comprises a gas separation layer, a first gas volume and a second gas volume, the gas separation layer being arranged between the first gas volume and the second gas volume, the gas separation layer having at least one aperture connecting the first gas volume to the second gas volume. The aperture is configured to taper from the first gas volume to the second gas volume and being dimensioned to enrich a component of the second gas volume in the first gas volume, wherein the aperture is configured as an elongated opening in the gas separation layer, the aperture having a minimum opening width of essentially one time to twenty times the mean free path length of the component of the second gas volume, which is to be enriched.

According to a second aspect, a gas separation device comprises a gas separation layer, a first gas volume and a second gas volume, the gas separation layer being arranged between the first gas volume and the second gas volume, the gas separation layer having at least one aperture connecting the first gas volume to the second gas volume. The aperture is configured to taper from the first gas volume to the second gas volume and being dimensioned to enrich a component of the second gas volume in the first gas volume, wherein the aperture is configured as an elongated opening in the gas separation layer. The gas separation layer comprises a first plate-like separation element and a second plate-like separation element, the first separation element being arranged opposite to and at an acute angle with regard to the second separation element, and the aperture being arranged between the first and the second separation element.

According to a third aspect, a gas separation device is manufactured in drum-shaped form, wherein a aperture with the minimum opening width is introduced into a plate-like base body of a gas separation layer by means of a tool, the plate-like base body of the gas separation layer being rolled, a rolling radius determining the opening angle of the aperture of the gas separation layer.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a schematic sectional view through a gas separation device.

FIG. 2 shows a perspective view of an aperture of the gas separation device.

FIG. 3 shows a schematic view of the aperture in the minimal opening region.

FIGS. 4 and 5 show a drum-shape configuration of a gas separation layer of the gas separation device.

FIG. 6 shows a modification of the drum-shaped gas separation layer of the gas separation device shown in FIGS. 4 and 5.

FIG. 7 shows a further modification of a drum-shaped gas separation layer.

FIGS. 8 and 9 show perspective views of the gas separation layer comprising a plurality of separation elements and connectors.

FIG. 10 shows a perspective view of a modification of the connectors shown in FIGS. 8 and 9.

FIG. 11 shows a modification of the connectors shown in FIG. 10.

### DETAILED DESCRIPTION OF THE EMBODIMENT(S)

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

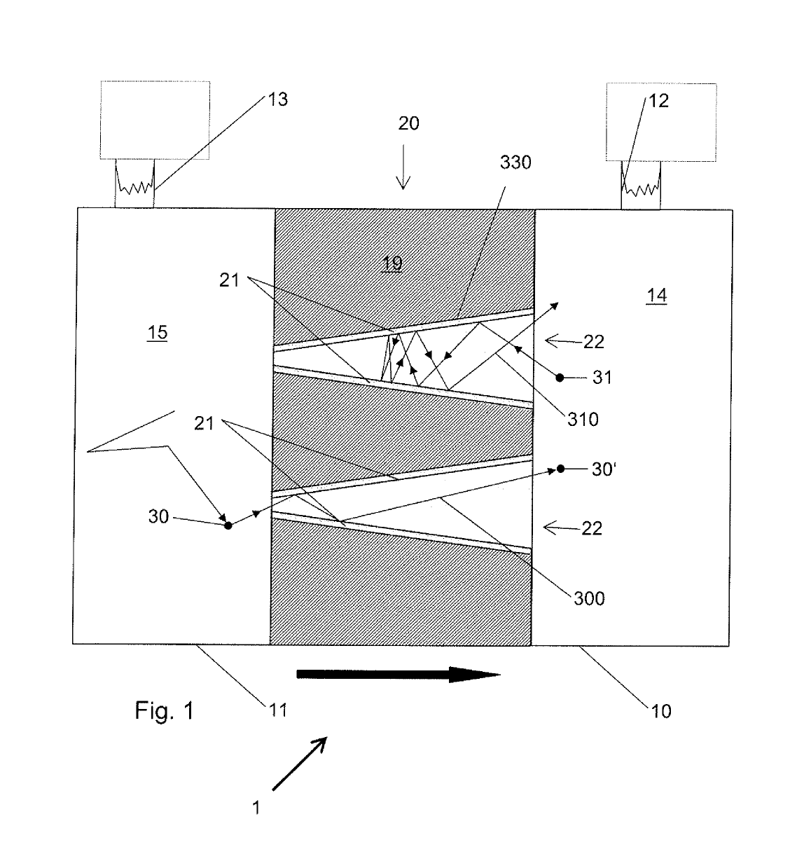

FIG. 1 shows a schematic sectional view of a gas separation device 1. The gas separation device 1 comprises a first container 10 with a first gas volume 14 and a second container 11 with a second gas volume 15. Thereby, the first gas volume 14 comprises a first gas mixture and the second gas volume 15 comprises a second gas mixture which differs from the first gas mixture. The containers 10, 11 each comprise a connecting line 12, 13 in order to connect the containers 10, 11 e.g. to measuring equipment, further tanks, facilities or with the surroundings.

Between the first container 10 and the second container 15, a first gas separation layer 20 is arranged, the two gas volumes 14, 15 in the two containers 10, 11 being connected to each other by means of the first gas separation layer 20. For this purpose, the first gas separation layer 20 comprises a plurality of apertures 22. The aperture 22 has a V-shaped cross-section, an opening angle α not being depicted to scale in FIG. 1.

In the drawing plane, the aperture 22 is configured as an elongated opening in the first gas separation layer 20. The aperture 22 is configured to taper from the first gas volume 14 to the second gas volume 15 in the container 11. At its narrowest location which is arranged on the side of the gas separation layer 20 facing the second container 11, the aperture 22 comprises a minimum opening width d.

The first gas separation layer 20 comprises a base body 19 as well a gas reflection layer 21 which covers the base body 19 of the first gas separation layer 20 at a surface 330 of the base body 19 in the region of the aperture 22.

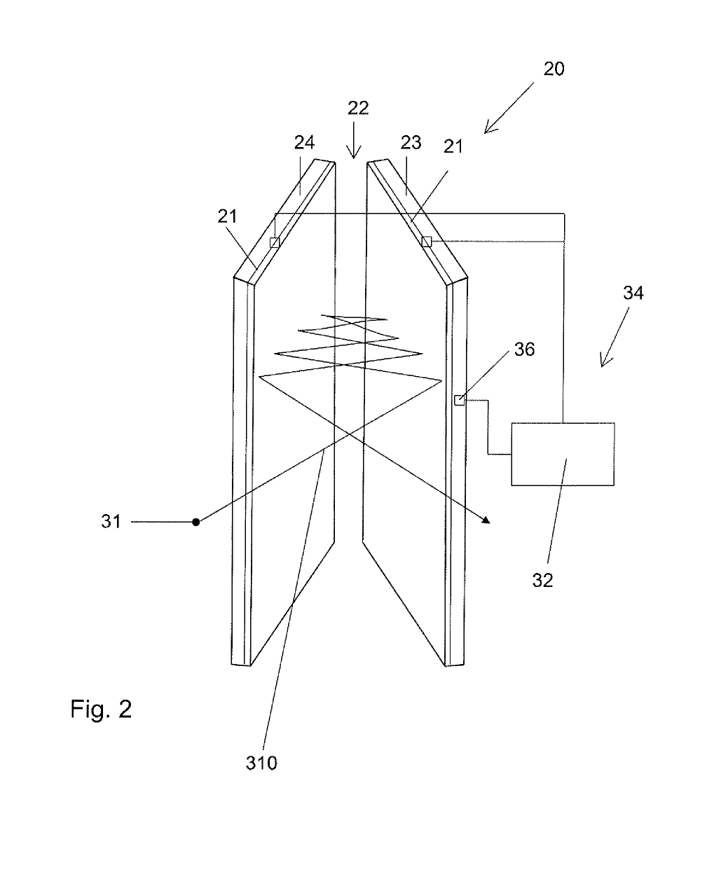

FIG. 1 symbolically shows an atom or, respectively, a molecule of a component 30 of the second gas volume 15 or, respectively, of the second gas mixture. Furthermore, a first path 300 of the atom or, respectively, molecule of the component 30 of the second gas volume 15 is indicated schematically. Likewise, a second path 310 of a component 31 of the first gas volume 14 is depicted. The path 300, 310 of the components 30, 31 of the gas volumes 14, 15 is random and characterized by the Brownian movement of molecules. It is particularly pointed out that as a result, the paths 300, 310 shown in FIGS. 1 and 2 are exemplary.

If the component 30 of the second gas volume 15 hits the aperture 22 on its first path 300, the component 30 of the second gas volume 15 is reflected at the gas reflection layer 21 once it comes into contact with it. In this context, the V-shaped and tapered configuration of the aperture 22 causes the component 30 of the second gas volume 15 moving from the second gas volume 15 to first gas volume 14 to be reflected at the gas reflection layer 21 in such a way that the component 30 is reflected in the direction of the first gas volume 14 or, respectively, in the direction of the first container 10. In order to reach the first container 10, several reflections of the component 30 of the second gas volume 15 at the reflection layer 21 of the aperture 22 may by all means be necessary.

The minimum opening width d of the aperture 22 is adjusted to the component 30 of the second gas volume 15, wherein the minimum opening width d is in the region of one time up to twenty times the mean free path length of the component 30 of the second gas volume 15. Particularly, a minimum opening width d in the region of ten times the mean free path length of the component 30 of the second gas volume 15 has proven to be particularly advantageous. This results in the fact that only the molecules or atoms of the second gas volume 15 which have a mean free path length in the region of one time up to twenty times the mean free path length, migrate from the second container 11 to the first gas volume 14.

The component 31 comprised by the first gas volume 14 shows the exemplary second path 310. Thereby, the atom or, respectively, the molecule of the component 31 of the first gas volume 14 enters the aperture 22 from the side of the first container 10. In its second path 310, the component 31 of the first gas volume 14 is reflected at the gas reflection layer 21 several times, wherein the component 31 of the first gas volume 14 is reflected back into the first container 10 due to the tapered V-shaped cross-section of the aperture 22 via multiple reflections. A passage through the aperture 22 from the first container 10 to the second container 11 is only possible if the component 31 of the first gas volume shows a path of motion 310 which allows for passage through the aperture 22 without contact. Since this second path 310 is random and temperature-dependent, the probability of the component 31 passing from the first gas volume 14 to the second gas volume 15 is low.

The probability that the component 30 of the second gas volume 15 hits the aperture 22 in its first path 300 is much higher than the above-described probability of a direct passage of the component 31 of the first gas volume 14. This results in the fact that the component 30 of the second gas volume 15 is enriched in the first gas volume 14. In FIG. 1, the direction of enrichment is additionally indicated by means of an arrow.

If the component 30 of the second gas volume 15, which is to be enriched, is located in the first container, it is subject to the same conditions as the component 31 of the first gas volume 14 so that the way back to the second container 11 is almost blocked for the component 30 of the second gas volume 15 in the first container 11, which is to be enriched, as is also described above for the first component 30. This gas separation device 1 is particularly suitable for extracting inert gases from a gas mixture. As an example, the use of the gas separation device 1 is advantageous during the extraction of helium from air or natural gas. In this application, the proposed embodiment is technically easier and more cost-efficient than the methods and devices so far known for the extraction of helium from air or natural gas.

Alternatively, the gas separation device is also suitable in a detector unit for facilitating the detection of predetermined gases.

It is also conceivable to use the gas separation device 1 in order to purify the exhaust fumes of power stations or motor vehicles. In this context, the gas separation device 1 may be used for the deposition of carbon dioxide. The deposited carbon dioxide may be stored upon separation. Thereby, the gas separation device 1 has a configuration which is simpler, more energy-efficient and provides more available space compared to other techniques such as various configurations of scrubbers (e.g. amine or carbonate scrubbers). Moreover, the gas separation device 1 may be used for desulphurizing flue gases so that a plurality of gas separation devices 1, arranged, as the case may be, in a cascade-like manner, may be used in power stations and/or motor vehicles for exhaust gas treatment.

In order to guarantee a high flow rate in the enrichment of the component 30 of the second gas volume 15 in the first gas volume 14, the V-shaped opening of the aperture 22 comprises an opening angle α of 0.01° up to 10°, particularly of 0.7°. Due to the small opening angle α, numerous apertures 22 may be arranged close to one another and in parallel in the first gas separation layer 20. In addition to the configuration of the aperture 22, this increases the flow rate.

In the embodiment, the gas reflection layer 21 may be configured in the form of a coating of a base body 19 of the first gas separation layer 20. Additionally or alternatively, the gas reflection layer 21 may be manufactured by means of a surface treatment, which is applied to the base body 19 of the first gas separation layer 20. Depending on the two gas volumes 14, 15, particularly depending on the component 30 of the second gas volume 15, the gas reflection layer 21 may comprise at least one of the following materials: metal, particularly gold, silver, copper, chromium, tin, zinc, nickel; a metallic structure comprising a crystalline structure comprising diamond, silicon nitride, silicon dioxide, metal/silicon-hybrid, titan nitride, tin oxide, silicon carbite, grease, wax, alcohol with long alkyl residues, alkine, ceramics, particularly silicate ceramics, oxide ceramics, glass ceramics, mixed ceramics; polymers, particularly thermoplastics, elastomers, thermosetting materials. In this context, the gas reflection layer 21 is particularly suitable for protecting the base body 19 of the first gas separation layer 20 against chemical wear.

In addition, the gas reflection layer 21 may prevent a narrowing or, respectively, a blocking of the aperture 22 by particles or gas components, particularly in the region of the minimum opening width d of the aperture 22. Due to the moisture also present in the gas volumes 14, 15, it is in an advantageous manner obvious to configure the gas reflection layer 21 with hydrophobic properties, particularly with a lotus effect. For this purpose, the gas reflection layer 21 may e.g. be configured as a nano-surface coating and/or as a nano structure in order to achieve the lotus effect, and/or as a powder coating.

In order to deposit the gas reflection layer 21 onto the base body 19 of the first gas separation layer 20, at least one of the following production methods is particularly suitable: acetylation, acylation, carboxylation, decarboxylation, hydroxylation, generation of hydrogels, methylation, silylation, sulphonation, graphite deposition methods, modification by means of functional polymers, forming dendritic structures, chromating, sputtering, eloxation, zinc coating, tin coating, chemical nickel, vapour deposition, synthesizing of fields of carbon nano-tubes, doping, powder deposition. Apart from this, the silanisation of the gas reflection layer 21 has proven to be particularly advantageous.

Alternatively or additionally, the gas reflection layer 21 may also be produced on the base body 19 of the first gas separation layer 20 by means of a surface treatment in the region of the aperture 22. Advantageously, during surface treatment, a roughness Rz is provided in the region of 0.3 up to ten times the mean free path length so that the component 30 of the second gas volume 15 is not reflected back in the direction of the second container 11 or, respectively, of the second gas volume 15 at an elevation in the aperture 22. In particular, at least one of the following manufacturing processes, by means of which the surface 330 of the aperture 22 is post-treated, is suitable for manufacturing the gas reflection layer 21 from the base body 19 of the first gas separation layer 20: lapping, polishing, acidic etching, alkaline etching, laser interference method. Apart from the roughness Rz of the surface 330 of the base body 19, a ripple of the surface 330 of the base body 19, as well, may be reliably promoted by means of these production methods in order to prevent a back-reflection of the component 30 of the second gas volume 15 in the same manner as in the case of the roughness Rz of the surface.

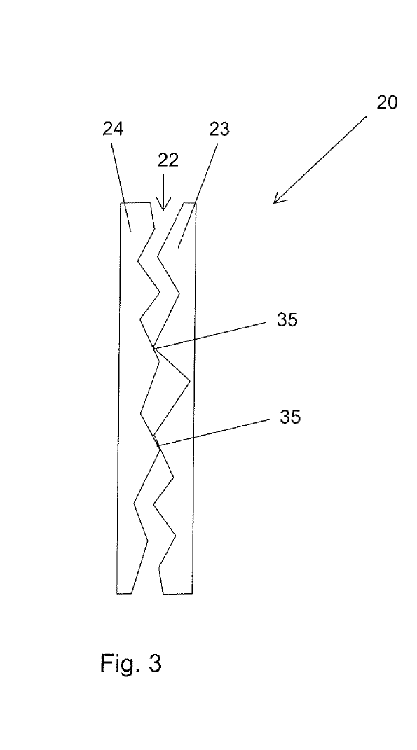

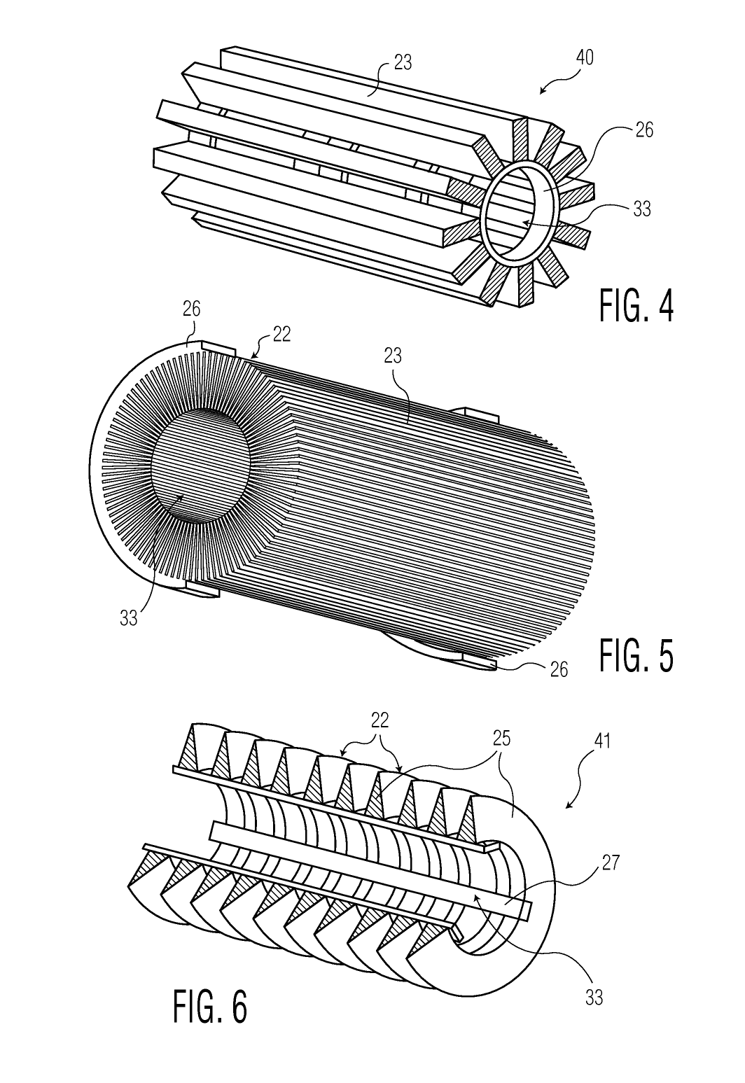

The material of the base body 19 of the first gas separation layer 20 may have different properties, depending on the purpose of use. In particular, at least one of the following materials is suitable for the base body 19 of the first gas separation layer 20: glasses, particularly soda-lime-glass, quartz glass, lead glass, boron silicate glass, borophosphate glass, alumosilicate glass, fluoride glass, chalcogenide glass; metals, particularly iron, aluminium, copper, tin, zinc, magnesium, nickel, chromium, silicon, carbon; rubbery materials, particularly silicone, natural rubber, latex; polymers such as polycarbonate, thermoplasts, elastomers and thermosetting materials; ceramics such as silicate ceramics, oxide ceramics, glass ceramics and mixed ceramics. In this context, the choice of the material of the base body 19 is to be adjusted to the assembly of the first gas separation layer 20 described in detail in FIGS. 3 and 4 and, as the case may be, to the components of the gas volumes 14, 15 in order to prevent a chemical reaction of the components of the gas volumes 14, 15 with the material of the base body 19.

If the material of the base body 19 of the first gas separation layer 20 consists of a flexible material, the gas reflection layer 21 may be deposited by providing the flexible material of the base body 19 with an aperture 22 and subsequently tensioning it transversely with regard to the aperture 22. Thereby, the aperture 22 is elastically widened. The gas reflection layer 21 is at least deposited in the region of the aperture 22 on the tensioned base body 19. Spraying is particularly suitable for depositing the gas reflection layer 21. After depositing the gas reflection layer 21, the tension of the base body 19 is loosened so that the first gas separation layer 20 eases into its final state. This safeguards a sufficient and complete coating of the aperture 22 of the first gas separation layer 20. In order to avoid spalling of the gas reflection layer 21, the choice of material of the gas reflection layer 21 is to be adjusted to the elastic material of the base body 19.

FIG. 2 shows a perspective view of the aperture 22 of the first gas separation layer 20. The first gas separation layer 20 herein comprises a first plate-like separation element 23 and a second plate-like separation element 24, the two separation elements 23, 24 being arranged at an acute angle with regard to each other. The angle of vision of FIG. 2 is from the first container shown in FIG. 1 onto the aperture 22. Furthermore, the second path 310 of the component 31 of the first gas volume 14 is depicted, as well.

The two separation elements 23, 24 also comprise the gas reflection layer 21. In order to enhance a transport of the component 30 of the second gas volume 15 to the first gas volume 14, the gas separation device comprises a heating unit 34. For this purpose, the gas reflection layer 21 of FIG. 2 is manufactured from a metallic, electrically conductive material. The gas reflection layer 21 is connected to a control device 32 by its ends. Moreover, the control unit 32 is additionally connected to a temperature sensor 36 arranged at the gas reflection layer 21, the temperature sensor 36 providing a temperature signal to the control device 32. The control device 32 energizes the gas reflection layer 21 depending on the temperature signal of the temperature sensor 36 in order to heat the gas reflection layer 21 with regard to the two gas volumes 14, 15. This heating of the gas reflection layer 21 increases the flow rate of the component 30 of the second gas volume 15, which is to be enriched, from the second gas volume 15 to the first gas volume 14.

As an alternative, it is conceivable that a heating coil is integrated into the base body 19 or, respectively, into the separation elements 23, 24 for heating the first gas separation layer 20. Cooling of the gas reflection layer 20 by means of a cooling unit is also conceivable. Particularly, the heating or cooling unit 34 may be configured as a Peltier element. Furthermore, it is additionally or alternatively conceivable to use a semiconducting material as a material for the gas separation layer shown in FIG. 2. As an alternative to the control device 32, other current sources are conceivable, as well.

FIG. 3 shows a schematic view of the aperture 22 in the region of the minimum opening width d of the aperture 22. In this context, the two separation elements 23, 24 are arranged opposite to each other and not drawn to scale. The jagged lines which face each other are intended to represent a roughness Rz of the surfaces 10 of the separation elements 23, 24 or, respectively, a roughness Rz of the gas reflection layer 21. In this context, the aperture 22 arranged between the separation elements 23, 24 comprises a fluctuating local minimum opening width d which due to the surfaces 19 of the separation elements 23, 24 is influenced by grooves 1, bumps or other elevations or dips. The roughness Rz of the surfaces 19 of the separation elements 23, 24 may specifically be used in order to determine the minimum opening width d of the aperture 22 of the first gas separation layer 20. For this purpose, the roughnesses Rz of the surfaces 19 of the separation elements 23, 24 are adjusted to those of the minimum opening width d. In order to adjust the minimum opening width d of the aperture 22, the separation elements 23, 24 are approximated to each other in a slanted manner during assembly. If brought into contact, the surfaces 19 of the separation elements 23, 24 touch at individual structural points 35. Between the structural points 35, the aperture 22 is opened, the structural points 35 determining the minimum opening width d.

The structural points 35 are in this context randomly determined by the quality of the surfaces 19. The structural points 35 are in this context determined by the different geometrical levellings of the two surfaces 19.

Depending on the choice of material for the separation elements 23, 24, the separation elements 23, 24 abut each other either in a point-wise manner in at least one structural point 35 or, in the case of soft materials, in a planar manner around the structural point 35. In the case of softer materials, particularly e.g. in the case of plastics, metal, rubber or latex, the minimum opening width d of the aperture 22 may be flexibly adjusted to the desired minimum opening width d by pressing against the separation elements 23, 24. In particular, the desired minimum opening width d may be provided if a roughness Rz is chosen in the region of 0.3 up to ten times the mean free path length. This roughness range also guarantees a reliable reflection of the component 30, 31 of the second or, respectively, of the first gas volume 14, 15 in the direction of the first container 10 and thus prevents a back reflection of the component 30 in the direction of the second container 11.

In order to provide a V-shaped opening of the aperture 22, the separation elements 23, 24 are, as described above, approximated to each other in a slanted manner during assembly, until the separation elements 23, 24 touch. This contact takes place in the contact area of the two separation elements 23, 24, so that the minimum opening width d of the aperture 22 is not only influenced by the roughness Rz, but also by the state of the edges. In the embodiment, the edge state is smaller or equal to the mean free path length so that a nick at the first separation element 23 hardly influences the minimum opening width d. In this context, the minimum opening width d of the aperture 22 corresponds to the mean free path length. If at least one of the separation elements 23, 24 exhibits a reduced edge state, the nicks increase the minimum opening width 5 and thus reduce the effectiveness of the first gas separation layer 20.

The ripple of the gas reflection layer 21 of the first gas separation layer 20 behaves in a similar way as the roughness Rz. In this context, the ripple should preferably be chosen to be smaller than the minimum opening width d of the aperture 22 of the first gas separation layer 20 at the surfaces of the separation elements 23, 24 in order to prevent the aperture 22 from exceeding a predetermined minimum opening width d. In a manner analogous to the roughness Rz of the surfaces 19 of the gas separation layer 20 with regard to the ripple, shared structural points 35 may also be formed in the area of the minimum opening width d of the aperture 22, said structural points 35 determining the minimum opening width d of the aperture.

Determining the minimum opening width d by means of the roughness Rz or, respectively, by means of the ripple of the surfaces 19 of the separation elements 23, 24 facilitates an assembly and adjustment of the gas separation layer 20.

FIGS. 4 and 5 show an alternative arrangement of the plate-shaped separation elements 23, 24 of the gas separation device 1. In this context, the plate-shaped separation elements 23, 24 are arranged in the shape of a drum in order to form a second gas separation layer 40 at a ring-shaped connecting element 26. By arranging the plate-shaped separation elements 23, 24 at the ring-shaped connectors 26 by their undersides, they have a V-shaped alignment with regard to each other. In this context, the opening angle α between the separation elements 23, 24 may be set by varying the number and the thickness of the plate-shaped separation elements 23, 24.

In the embodiment shown in FIGS. 4 and 5, an internal space 33 of the drum-shaped second gas separation layer 40 is connected to the second container 11 shown in FIG. 1, and a space around the drum-shaped separation elements 23, 24 arranged in a drum-shaped manner is connected to the first container 10. The drum-shaped arrangement of the separation elements 23, 24 allows for a spatially favourable embodiment of the second gas separation layer 40 and may for example be arranged in a tube-like device between the first and the second container 10, 11.

FIG. 6 shows an alternative embodiment of a third gas separation layer 41 of the drum-like gas separation layer 40 depicted in FIGS. 4 and 5. Said gas separation layer comprises ring-shaped separation elements 25 which are connected to one another by means of beam-like connectors 27. Particularly, a distance or, respectively, the minimum opening width d between the individual ring-shaped separation elements 25 may be determined by means of the roughness Rz or, respectively, the ripple of the ring-shaped separation elements 25 in the area of the minimum opening width d, as described in conjunction with FIG. 3. In the embodiment shown in FIG. 6, the beam-like connectors 27 are arranged transversely to the ring-shaped separation elements 25, wherein in each case one connector 27 connects all separation elements 25. Of course, it is also conceivable that the connector 27 only connects individual separation elements 25 to each other. Moreover, alternative embodiments of the connector 27 are conceivable, as well.

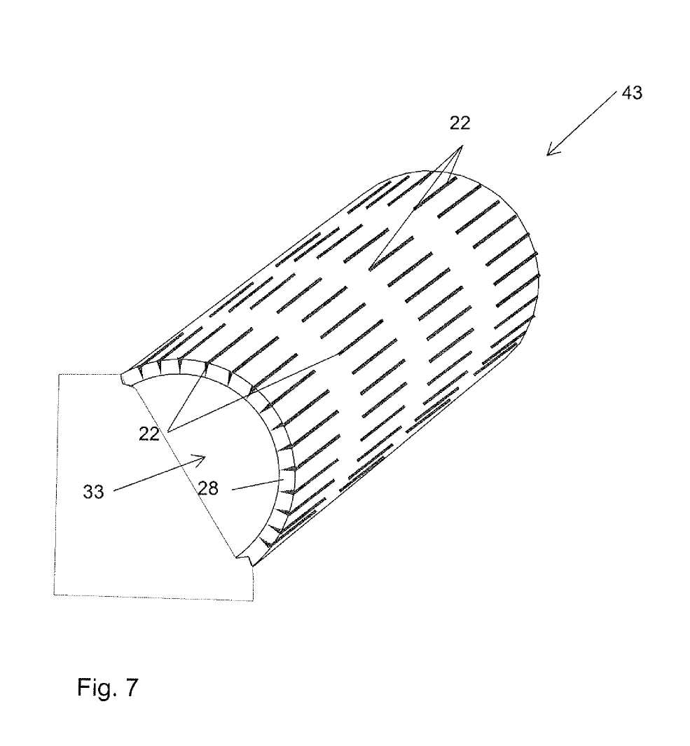

FIG. 7 shows a drum-shaped fourth gas separation layer 43. Said gas separation layer 43 comprises individual apertures 22 which are arranged in a plate-shaped base body 28 of the fourth gas separation layer 43 as staggered openings. In order to manufacture a drum-shaped fourth gas separation layer 43, the plate-shaped base body 28 of the gas separation layer 20 is provided with apertures 22 having the minimum opening width d by means of a tool. This may e.g. be carried out by means of stamping, laser cutting or water jet cutting. Subsequently, the base body 28 is rolled, a rolling radius determining the opening angle of the apertures 22. Thereby, the internal space 33 of the gas separation device 1 may be connected to the second gas volume 14 of the second container 11, in the same manner as explained in conjunction with FIGS. 4 to 6. The external space around the gas separation device 20 is also connected to the first container 10 and the first gas volume 14. Of course, after rolling all undesignated accesses to the internal space 33 are to be sealed off in order to prevent a bypass flow circumventing the apertures 22.

As materials for the plate-like base body 28 of the drum-like fourth gas separation layer 43, materials which may be stamped and/or cut as well as rolled are particularly suitable. In particular, all metals and alloys therefrom may be used, as well as plastics, rubber and latex.

In FIGS. 8 to 11, different embodiments of the gas separation layer 20 are depicted with triangle-shaped separation elements 29.

FIGS. 8 and 9 show a fifth gas separation layer 44 comprising a plurality of triangle-shaped separation elements 29 on connectors 27 having a beam-like configuration. Thereby, the triangle-shaped separation elements 29 are fastened to the beam-shaped connectors 27 by an underside 35, so that the apertures 22 are formed with a V-shaped cross-section between the triangle-shaped separation elements 29. Here, the triangle-shaped separation elements 29 may be brought into contact with one another in order to determine the minimum opening width d of the aperture 22. Of course, it is also conceivable to determine the minimum opening width d by arranging the triangle-shaped separation elements 29 at the connectors 27 selectively and at a distance.

In a preferred embodiment, a temperature-proof material exhibiting a low thermal expansion coefficient may be used for the connector 27 in order to maintain an almost stable minimum opening width d via a temperature range. In this context, ceramics are particularly suitable materials for the connectors 27.

As an alternative to a temperature-stable connector 27, the alternative connector 270 in the alternative shown in FIG. 9 comprises a distance adjustment unit 271 which is arranged in the area of the minimum opening width d in the alternative connector 270. A non-depicted further control device is connected to the distance adjustment unit 271 and configured to activate the distance adjustment unit 271 in order to vary the distance or, respectively, the minimum opening width d of the triangle-shaped separation elements 29. This embodiment allows for adjusting the minimum opening width d of the apertures 22 to the mean free path length of the component 30 of the second gas volume 15. Piezo elements or electro-active polymers are particularly suitable for the distance adjustment unit 271. Of course, other distance adjustment units 271 varying the distance of the separation elements 29 to each other may be used as an alternative to the piezo elements.

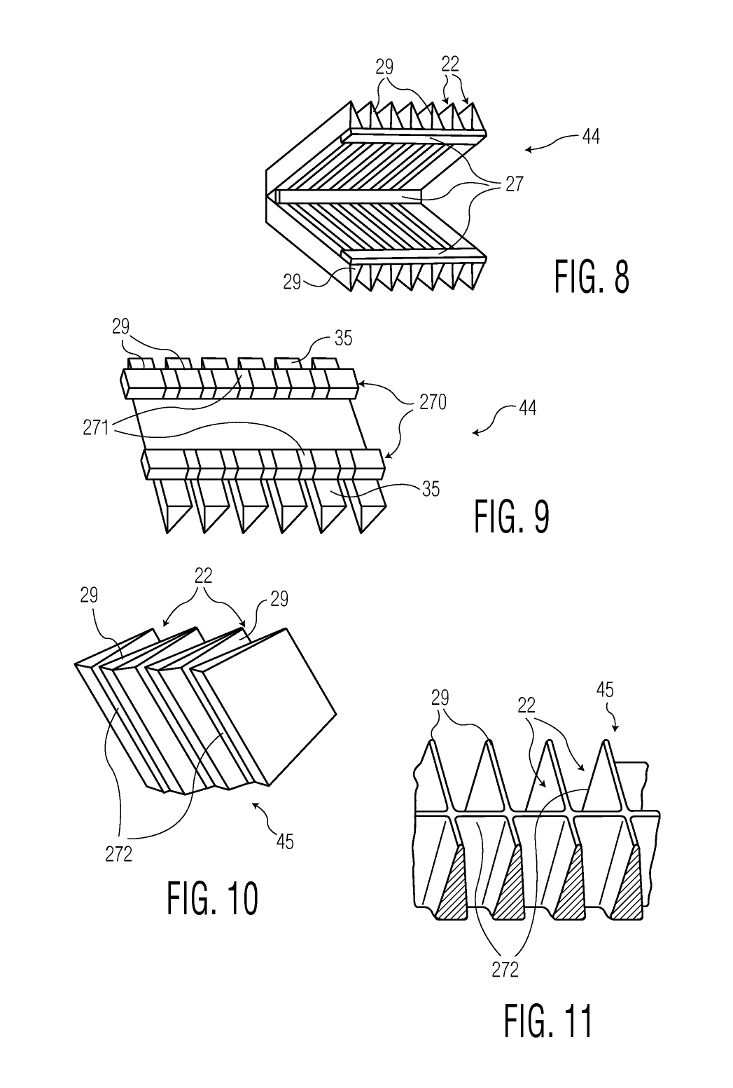

FIGS. 10 and 11 show an alternative embodiment of the connectors 272 of a sixth gas separation layer 45 comprising the triangle-shaped separation elements 29 depicted in FIGS. 8 and 9 in a perspective view. Thereby, the connectors 272 are arranged between the separation elements 29 in a beam-shaped manner. This embodiment allows for a particularly flat design of the gas separation layer 20. In this context, the connectors 272 may be manufactured of the same material as the triangle-shaped separation elements 29. The shown embodiment is particularly suitable in order to manufacture the sixth gas separation layer 45 in a sintering process.

FIG. 11 shows a perspective view of the embodiment of the sixth gas separation layer 45 shown in FIG. 12. Thereby, the connectors 272 are configured as bars which have the same height as the triangle-shaped separation elements 29. The distance of the connectors 272 with regard to one another alongside a separation element 29 is at least ten times the minimum width d of the aperture 22. In this manner, it is safeguarded that a sufficient flow rate of the component 30 from the second gas volume 15 to the first gas volume is guaranteed with simultaneous rigidness. By means of this embodiment, a reliable support of the triangle-shaped separation elements with regard to vibrations may be guaranteed so that the gas separation device 20 may e.g. be used in a motor vehicle, as well.

The embodiments of the gas separation layer 20, 40, 41, 43, 44, 45 of the gas separation device 1 and their components, which are explained in conjunction with the figures are preferred or, respectively, exemplary embodiments of the invention. Apart from the described and depicted embodiments, further embodiments are conceivable which may comprise further modifications or, respectively, combinations of the described features.

A gas separation device comprises a gas separation layer, a first gas volume and a second gas volume is proposed, the gas separation layer being arranged between the first gas volume and the second gas volume. Here, the gas volumes are connected to each other by means of the gas separation layer. The gas separation layer comprises at least one aperture. The aperture connects the first gas volume to the second gas volume and is configured to taper from the first gas volume to the second gas volume, and it is dimensioned to enrich a component of the second gas volume in the first gas volume. Furthermore, the aperture is configured as an elongated opening in the gas separation layer and/or comprises a gas reflection layer at a surface of the aperture. Furthermore, the aperture has a minimum opening width of essentially one time to twenty times the mean free path length of the component of the second gas volume, which is to be enriched.

This configuration allows for an increased enrichment speed (or, respectively, for an increased flow rate) of the component of the second gas volume in the first gas volume. Moreover, compared to a capillary which is usually configured as a long, thin tube-shaped channel, the aperture is significantly easier to manufacture. Furthermore, the additional or alternative gas reflection layer may reduce wear on the gas separation layer with regard to different gas mixtures.

In a further embodiment, the aperture has a V-shaped cross-section, the opening angle of which is essentially 0.01° to 10°, particularly essentially 0.7°. This embodiment allows for reliable back-reflection of gas atoms or, respectively, gas molecules of the first gas volume which are not to pass the gas separation layer so that a transition of atoms or, respectively, molecules of the first gas volume to the second gas volume is reliably prevented.

In a further embodiment, the gas separation layer comprises a first separation element configured in the shape of a plate and a second separation element configured in the shape of a plate wherein the first separation element is arranged opposite to the second separation element at an acute angle and wherein an aperture is arranged between the first and the second separation element. This ensures an inexpensive configuration of the gas separation layer.

In a further embodiment, the gas separation layer comprises at least two triangle-shaped separation elements and at least one connector, the separation elements of the gas separation layer being fastened to the connector. The aperture is arranged between the two separation elements. This configuration allows for reliably determining the opening angle of the aperture by configuring the triangle-shaped separation elements. Furthermore, the connector reliably guarantees the distance between the two separation elements which is predetermined and adjusted to the second gas volume's component which is to be enriched.

In a further embodiment, the connector of the separation elements is configured in an adjustable manner in order to vary a distance of the separation elements with regard to each other. This possibility of configuration allows for adjusting the gas separation layer to different components to be enriched or, respectively, to differing gas mixtures of the gas volumes, wherein the minimum opening width of the aperture may be adjusted to the mean free path length of the component to be enriched.

In a further embodiment, a plurality of separation elements is arranged in a drum-like manner. In this context, an internal space of the drum-like arrangement of the separation elements is connected to the second gas volume and at least a part of the external space around the drum-like arrangement of the separation elements is connected to the first gas volume. This embodiment allows for a variant of the gas separation device which is optimized with regard to its available space.

In a further embodiment, the first and the second separation element of the gas separation layer have a structured surface and at least one shared structural point. In this context, the structured surfaces of the two separation elements are configured in such a way that the structural point determines the minimum opening width of the aperture between the separation elements. This configuration allows for a simple distance determination of the separation elements of the gas separation layer with regard to one another.

In a further embodiment, the length of the aperture is at least ten times as much as the minimum opening width of the aperture of the gas separation layer. This configuration allows for a particularly high flow rate of the component of the second gas volume in the direction of the first gas volume.

In a further embodiment, the gas reflection layer of the gas separation layer comprises a roughness Rz of 0.3 to 10 times the mean free path length. This roughness additionally enhances a reliable enrichment of the component of the second gas volume in the first gas volume.

In a further embodiment, a ripple of the gas reflection layer of the gas separation layer is smaller than the minimum opening width of the aperture of the gas separation layer. In this manner, exceeding the minimum opening width of the gas separation layer is prevented so that the two gas volumes are reliably separated from each other and the enrichment of the second gas volume's component in the first gas volume is ensured.

In a further embodiment, the gas separation layer comprises a heating or cooling unit which is configured to heat or cool the gas separation layer and to provide a temperature difference with regard to the first and/or the second gas volumes. This configuration promotes the enrichment of the component of the second gas volume in the first gas volume.

In this context, it is particularly advantageous if the heating or cooling unit comprises the gas reflection layer. The heating or cooling unit of the gas reflection layer is herein preferably configured as a Peltier element. As a raw material, the gas reflection layer comprises a metallic, electrically conductive and/or semiconductive material. In this context, the gas reflection layer is connected to a current source and/or to a control device of the heating or cooling unit in order to reliably control heating or cooling of the gas reflection layer in this manner.

In a further embodiment, the gas separation layer comprises at least one of the following materials: glasses, particularly soda-lime-glass, quartz glass, lead glass, boron silicate glass, boron phosphorus glass, alumino-silicate glass, fluoride glass, chalcogenide glass; metals, particularly iron, aluminium, copper, tin, zinc, magnesium, nickel, chromium, silicon, carbon; rubbery materials, in particular silicone, natural rubber, latex; polymers such as polycarbonates, thermoplasts, elastomers and thermosetting materials; ceramics such as silicate ceramics, oxide ceramics, glass ceramics and mixed ceramics. This configuration allows for adjusting the gas reflection layer to the two gas volumes or, respectively, to the component of the second gas volume, which is to be enriched in the first gas volume. Particularly, choosing from the named materials allows for preventing a reaction of the gas volumes with the gas separation layer.

In a further embodiment, a first pressure is applied to the first gas volume of the gas separation device and a second pressure is applied to the second gas volume of the gas separation device, wherein the second pressure of the second gas volume is increased with regard to the first pressure of the first gas volume. In this manner, the enrichment of the component of the second gas volume in the first gas volume may be accelerated.

The gas separation layer of the above-mentioned gas separation device may be manufactured by introducing at least one aperture in a flexible material of a base body by means of a tool, wherein the base body is subsequently tensioned and the reflection layer is subsequently deposited at least in the area of the aperture, particularly by means of spraying.

Moreover, properties of the gas reflection layer may be improved by means of a process which assigns hydrophic properties to the gas reflection layer, particularly a lotus effect.

In order to manufacture the drum-shaped configuration of the gas separation device in a simple manner, it is proposed to introduce an aperture with a minimum opening width into a plate-shaped base body of the gas separation layer by means of a tool. Subsequently, the plate-shaped base body of the gas separation layer is rolled, a rolling radius determining the opening angle of the aperture of the gas separation layer. This method e.g. allows for introducing the aperture into the base body of the gas separation layer in a cost-efficient manner by means of stamping or laser cutting, and to confer a desired opening angle to the aperture.

While the foregoing is directed to embodiments of the invention, other and further embodiments of this invention may be devised without departing from the basic scope of the invention, the scope of the present invention being determined by the claims that follow.

What is claimed is:

1. A gas separation device comprising a gas separation layer, a first gas volume and a second gas volume, the gas separation layer being arranged between the first gas volume and the second gas volume, the gas separation layer having at least one aperture connecting the first gas volume to the second gas volume, the aperture being configured to taper from the first gas volume to the second gas volume and being dimensioned to enrich a component of the second gas volume in the first gas volume, wherein the aperture is configured as an elongated opening in the gas separation layer, the aperture having a minimum opening width of essentially one time to twenty times a mean free path length of the component of the second gas volume, which is to be enriched.

2. The gas separation device of claim 1, wherein the aperture has a V-shaped cross-section, an opening angle of the aperture being in the range of 0.01° to 10°.

3. The gas separation device of claim 2, wherein the aperture opening angle of the aperture is 0.7°.

4. The gas separation device of claim 1, wherein the length of the aperture is at least ten times the minimum opening width of the aperture of the gas separation layer.

5. The gas separation device of claim 1, wherein the gas separation layer comprises at least two triangle-shaped separation elements and at least one connector, the separation elements of the gas separation layer being fastened to the connector, and the aperture being arranged between the two separation elements.

6. The gas separation device of claim 1, wherein the aperture comprises a gas reflection layer on a surface.

7. The gas separation device of claim 6, wherein the gas reflection layer of the gas separation layer has a roughness Rz of 0.3 to 10 times the mean free path length.

8. The gas separation device of claim 6, wherein a ripple of the gas reflection layer of the gas separation layer is smaller than the minimum opening width of the aperture of the gas separation layer.

9. The gas separation device of claim 1, wherein the gas separation layer comprises a heating or cooling unit configured to heat or cool the gas separation layer and to provide a temperature gradient to any of the first and the second gas volume, the heating or cooling unit comprising the gas reflection layer, wherein the heating or cooling unit may particularly be configured as a Peltier element, wherein the gas reflection layer comprises any of a metallic, electrically conductive and semiconductive material and wherein the gas reflection layer is connected to a current source and/or to a control device.

10. A gas separation device comprising a gas separation layer, a first gas volume and a second gas volume, the gas separation layer being arranged between the first gas volume and the second gas volume, the gas separation layer having at least one aperture connecting the first gas volume to the second gas volume, the aperture being configured to taper from the first gas volume to the second gas volume and being dimensioned to enrich a component of the second gas volume in the first gas volume, wherein the aperture is configured as an elongated opening in the gas separation layer, wherein the gas separation layer comprises a first plate-like separation element and a second plate-like separation element, the first separation element being arranged opposite to and at an acute angle with regard to the second separation element, and the aperture being arranged between the first and the second separation element.

11. The gas separation device of claim 10, wherein the plate-shaped separation elements are arranged at a ring-shaped connector by their undersides, the plate-shaped separation elements having a V-shaped alignment with regard to each other.

12. The gas separation device of claim 10, wherein the connector is configured in an adjustable manner in order to vary a distance of the separation elements to each other.

13. The gas separation device of claim 10, wherein a plurality of separation elements are arranged in a drum-like manner, an internal space of the drum-like arrangement of the separation elements being connected to the second gas volume and at least one part of the external space around the drum-like arrangement of the separation elements being connected to the first gas volume.

14. The gas separation device of claim 10, wherein the first and the second separation element have a structured surface and at least one shared structural point, the structured surfaces of the two separation elements being configured in such a way that the structural point determines the minimum opening width of the aperture between the separation elements.

15. The gas separation device of claims 10, wherein the aperture comprises a gas reflection layer on a surface.

16. The gas separation device of claim 15, wherein the gas reflection layer of the gas separation layer has a roughness Rz of 0.3 to 10 times a mean free path length of the component of the second gas volume.

17. The gas separation device of claim 15, wherein a ripple of the gas reflection layer of the gas separation layer is smaller than a minimum opening width of the aperture of the gas separation layer.

18. The gas separation device of claim 15, wherein the gas separation layer comprises a heating or cooling unit configured to heat or cool the gas separation layer and to provide a temperature gradient to any of the first and to the second gas volume, the heating or cooling unit comprising the gas reflection layer, wherein the heating or cooling unit may particularly be configured as a Peltier element, wherein the gas reflection layer comprises any of a metallic, electrically conductive and semiconductive material and wherein the gas reflection layer is connected to a current source and/or to a control device.

19. A method for manufacturing a gas separation device in drum-shaped form, wherein a aperture with the minimum opening width is introduced into a plate-like base body of a gas separation layer by means of a tool, the plate-like base body of the gas separation layer being rolled, a rolling radius determining the opening angle of the aperture of the gas separation layer.

20. A method of claim 19, wherein at least one aperture is introduced into a flexible material of the base body by means of a tool, wherein the base body is subsequently tensioned and wherein a gas reflection layer is subsequently deposited at least in the area of the aperture, particularly by means of spraying.

21. The method of claim 20, wherein the gas reflection layer is post-treated by means of a method assigning hydrophobic properties to a gas reflection layer, particularly a lotus effect.
